(19) United States
(12) Patent Application Publication
(10) Pub. No.: US 2026/0179962 A1
(43) Pub. Date: Jun. 25, 2026

(54) BORON RICH ADDITIVE FOR SUPPRESSED THERMAL EVENTS IN ELECTROCHEMICAL CELLS

(71) Applicant: Solid Power Operating, Inc., Louisville, CO (US)

(72) Inventors: Benjamin A. CARLSON, St. Paul, MN (US); Forrest A. L. Laskowski, Bend, OR (US)

(21) Appl. No.: 19/430,095

(22) Filed: Dec. 22, 2025

Related U.S. Application Data
(60) Provisional application No. 63/738,271, filed on Dec. 23, 2024.

(51) Int. Cl. H01M 4/62; H01M 4/02; H01M 4/525; H01M 6/18; H01M 10/0562; H01M 50/434

(52) U.S. Cl. CPC H01M 4/628; H01M 4/525; H01M 4/622; H01M 4/625; H01M 50/434; H01M 2004/028; H01M 6/185; H01M 10/0562

(57) ABSTRACT

Cathode active materials coated with a boron-containing additive are useful for suppressing thermal events when used in an electrochemical cell. Electrochemical cells may include a cathode layer that includes a boron additive, or may include a layer that contains the boron additive.

### CROSS-REFERENCE TO RELATED APPLICATION

This application is related to and claims priority under 35 U.S.C. § 119(e) from U.S. Patent Application No. 63/738,271 filed Dec. 23, 2024, titled “Boron-Rich Additive for Suppressed Thermal Invents in Electrochemical Cells,” the entire contents of which is incorporated herein by reference for all purposes.

### TECHNICAL FIELD

Various embodiments described herein relate to the field of primary and secondary electrochemical cells, positive electrodes, and coating, and the corresponding methods of making and using the same.

### BACKGROUND

Batteries have become a ubiquitous product that has found its way into a multitude of everyday products ranging from cell phones and laptops to vehicles and even airplanes. As advances in battery technologies allow for greater and greater charging speeds and energy densities, the safety of these batteries becomes much more important. One major way a battery may pose a danger is when the battery experiences a thermal event where unintended heat may be generated. A common remedy is to produce batteries that have low power and energy density, the rationale being that the battery has less power and therefore is less likely to experience a very energetic thermal event.

Unfortunately, there has been little advancement in improving the safety of high energy density batteries such as those that use high-energy density cathode materials such as nickel-rich NMC (nickel-manganese-cobalt oxide) materials. The advancements that have been made tend to suppress the energy densities of these cells which makes them less attractive to the end user.

It is with these observations in mind, among others, that aspects of the present disclosure were conceived.

### SUMMARY

Provided herein are compositions that are suitable for use in an electrochemical cell comprising boron. Specifically, the composition includes a boron additive and a cathode active material having a surface, wherein the boron additive is in physical contact with the surface of the cathode active material. In some embodiments, the cathode active material comprises LiNiₐMn_{b}Co_{c}O₂, wherein 0<a<1, 0<b<1, 0<c<1 and a+b+c=1. In some embodiments, the boron additive comprises boron nitride, elemental boron, boron oxide (B₂O₃), H₃BO₃, Zn₃B₂O₆, or B₄C. In some embodiments, the composition further includes a conductive additive, wherein the conductive additive includes carbon fiber, graphite, graphene, carbon black, conductive carbon, amorphous carbon, VGCF, or carbon nanotubes. In some embodiments, the composition further includes a binder, wherein the binder comprises styrene-butadiene rubber (SBR), styrene-butadiene-styrene copolymer (SBS), styrene-isoprene block copolymer (SIS), or styrene-ethylene-butylene-styrene (SEBS). In some embodiments, the composition further comprises a solid electrolyte, wherein the solid electrolyte comprises Li_{7-y}PS_{6-y}X_{y}, wherein “X” represents a halogen, a pseudo-halogen, or a combination thereof; 0<y≤2.0; the halogen includes F, Cl, Br, I, or a combination thereof, and the pseudo-halogen includes N, NH, NH₂, NO, NO₂, BF₄, BH₄, AlH₄, CN, SCN, or a combination thereof.

Further provided herein is an electrochemical cell comprising: a first current collector layer; a cathode layer; a boron additive-containing layer having a thickness from about 0.5 μm to about 15 μm, wherein the boron layer is positioned between the first current collector layer and the cathode layer; a separator layer; an anode layer; and a second current collector layer. In some embodiments, the boron additive-containing layer comprises boron nitride, elemental boron, boron oxide (B₂O₃), H₃BO₃, Zn₃B₂O₆, or B₄C. In some embodiments, the boron additive-containing layer further comprises carbon fiber, graphite, graphene, carbon black, conductive carbon, amorphous carbon, VGCF, or carbon nanotubes. In some embodiments, the boron additive-containing layer comprises boron nitride and at least one additional boron-containing material, and the weight ratio of boron nitride to the at least one additional boron-containing material in the boron layer is greater than 50%. In some embodiments, the cathode layer comprises LiNiₐMn_{b}Co_{c}O₂, where 0<a<1, 0<b<1, 0<c<1, and a+b+c=1. In some embodiments, the separator layer comprises a solid electrolyte material which can be expressed as Li_{7-y}PS_{6-y}X_{y} where “X” represents at least one halogen and/or at least one pseudo-halogen, and where 0<y≤2.0 and where the halogen may be one or more of F, Cl, Br, I, and the pseudo-halogen may be one or more of N, NH, NH₂, NO, NO₂, BF₄, BH₄, AlH₄, CN, and SCN. In some embodiments, the anode layer comprises silicon, lithium, carbon, magnesium, indium, gallium, aluminum, calcium, silver, or tin.

Further provided herein is an electrochemical cell comprising: a first current collector layer; a cathode layer comprising a boron additive and a cathode active material having a surface, wherein the boron additive is in physical contact with the surface of the cathode active material, wherein the cathode layer is in electrical communication with the first current collector layer; a separator layer; an anode layer; and a second current collector layer, wherein the second current collector layer is in electrical communication with the anode layer. In some embodiments, the cathode active material comprises LiNiₐMn_{b}Co_{c}O₂, wherein 0<a<1, 0<b<1, 0<c<1 and a+b+c=1. In some embodiments, the boron additive comprises boron nitride, elemental boron, boron oxide (B₂O₃), H₃BO₃, Zn₃B₂O₆, or B₄C. In some embodiments, the cathode layer further comprising a conductive additive, wherein the conductive additive includes carbon fiber, graphite, graphene, carbon black, conductive carbon, amorphous carbon, VGCF, or carbon nanotubes. In some embodiments, the cathode layer further comprises a solid electrolyte, wherein the solid electrolyte comprises Li_{7-y}PS_{6-y}X_{y}, wherein “X” represents a halogen, a pseudo-halogen, or a combination thereof; 0<y≤2.0; the halogen includes F, Cl, Br, I, or a combination thereof, and the pseudo-halogen includes N, NH, NH₂, NO, NO₂, BF₄, BH₄, AlH₄, CN, SCN, or a combination thereof. In some embodiments, the anode layer comprises silicon, lithium, carbon, magnesium, indium, gallium, aluminum, calcium, silver, or tin.

### BRIEF DESCRIPTION OF THE DRAWINGS

The present disclosure may be understood by reference to the following detailed description taken in conjunction with the drawings briefly described below. It is noted that, for purposes of illustrative clarity, certain elements in the drawings may not be drawn to scale.

FIG. 1 is a schematic an example of cathode active material with a coating of the boron rich additive in accordance with an embodiment.

FIG. 2 is a flow chart of a process for applying the boron rich additive into the surface of a cathode active material and using the resultant material in an electrochemical cell, in accordance with an embodiment.

FIG. 3 is a schematic cross-sectional view of an example of the coated cathode active material used in the construction of an electrochemical cell, in accordance with an embodiment.

FIG. 4 is a schematic cross-sectional view of an example of an electrochemical cell comprising an additive containing layer proximate to the cathode active material containing layer in accordance with an embodiment.

### DETAILED DESCRIPTION

In the following description, specific details are provided to impart a thorough understanding of the various embodiments of the disclosure. Upon having read and understood the specification, claims, and drawings hereof, those skilled in the art will understand that some embodiments may be practiced without hewing to some of the specific details set forth herein. Moreover, to avoid obscuring the disclosure, some well-known methods, processes, devices, and systems utilized in the various embodiments described herein are not disclosed in detail.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity and in another example, a numerical range of “about 50 mg/mL to about 80 mg/mL” should also be understood to provide support for the range of “50 mg/mL to 80 mg/mL.”

Disclosed is an electrochemical cell (battery) or an electrode layer for use in a battery that contains a boron additive useful for suppressing a thermal event. The boron additive may be incorporated into the electrode layer such that the material is positioned within close proximity to the cathode active material and/or physically contacting the cathode active material. In some embodiments, the boron additive may form a coating layer on the cathode active material or other materials present in the electrode layer. Alternatively, the boron additive may also be incorporated into a battery component that is proximal to the electrode layer, such as in a primer coating (e.g., a carbon coating) that is applied to a current collector in the battery.

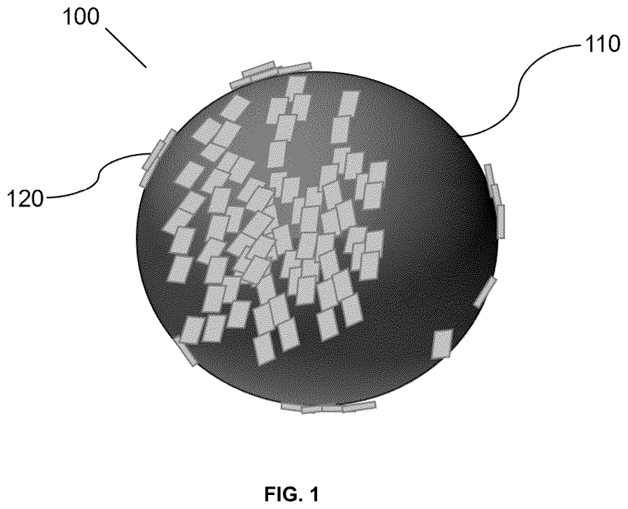

FIG. 1 is a schematic view of an example of a coated cathode active material 100 of the present disclosure. The coated cathode active material 100 includes a cathode active material 110 coated by a boron additive 120. Although the coated cathode active material 100 is shown as being perfectly spherical, those having ordinary skill in the art will appreciate that the coated cathode active material may have any shape. Further, although the boron additive 120 of the coated cathode active material 100 is shown as not uniformly coating the cathode active material 110, those having ordinary skill in the art will appreciate that the boron additive 120 may have a uniform thickness or may have a variable thickness over the cathode active material 110.

The cathode active material 110 may be, for example, a particle of NMC (nickel-manganese-cobalt) material ranging in size from about 1 micron to 20 microns in diameter. NMC material is stoichiometrically in the form of LiNiₐMn_{b}Co_{c}O₂, where 0<a<1, 0<b<1, 0<c<1 and a+b+c=1. In some examples, the NMC may include NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂), NMC 851005 (LiNi_{0.85}Mn_{0.05}Co_{0.1}O₂), or any combination thereof. The cathode active material 100 may include lithium, manganese, oxygen, cobalt, aluminum, zirconium, tungsten, vanadium, titanium, molybdenum, or any combination thereof.

In another embodiment, the cathode active material 110 may comprise a coated or uncoated metal oxide, such as but not limited to LiNiO₂, LiNi_{1-Y}Co_{Y}O₂ (where 0≤Y<1), LiNi_{1-Y}Mn_{Y}O₂ (where 0≤Y<1), Li(NiₐCo_{b}Mn_{c})O₄ (where 0<a<2, 0<b<2, 0<c<2, a+b+c=2), LiMn_{2-Z}Ni_{Z}O₄ (where 0<Z<2), Li(NiₐCo_{b}Al_{c})O₂ (where 0<a<1, 0<b<1, 0<c<1, a+b+c=1), or any combination thereof. In another embodiment, the cathode active material 110 may comprise a coated or uncoated metal oxide, such as but not limited to V₂O₅, V₆O₁₃, MoO₃, LiCoO₂, LiMnO₂, LiMn₂O₄, LiCo_{1-Y}Mn_{Y}O₂ (where 0≤Y<1), LiMn_{2-Z}Co_{Z}O₄ (0<Z<2), LiCoPO₄, LiFePO₄, CuO, or any combination thereof. The coated or uncoated metal oxide refers to a metal oxide that includes a native coating layer separate from the partial coatings described further herein. Generally, the native coating layer comprises oxygen and results from oxidation of the metal oxide.

In yet a further embodiment, the cathode active material 110 may comprise a coated or uncoated metal sulfide such as but not limited to titanium sulfide (TiS₂), molybdenum sulfide (MoS₂), iron sulfide (FeS, FeS₂), copper sulfide (CuS), nickel sulfide (Ni₃S₂) and lithium sulfide (Li₂S), or combination thereof. The coated or uncoated metal sulfide refers to a metal sulfide that includes a native coating layer separate from the boron additive coatings described further herein.

The cathode active material 110 has a boron additive 120 in contact with and covering at least part of the surface of the cathode active material 110. The layer formed by the boron additive 120 may be referred to herein as a coating layer. The boron additive 120 may comprise boron nitride (BN), elemental boron, boron oxide (B₂O₃), H₃BO₃, Zn₃B₂O₆, B₄C, or any combination thereof. In a particular embodiment, the boron additive includes boron nitride. The boron nitride may be amorphous (a-BN), hexagonal (h-BN), cubic (c-BN), Wurtzite (w-BN), or any combination thereof.

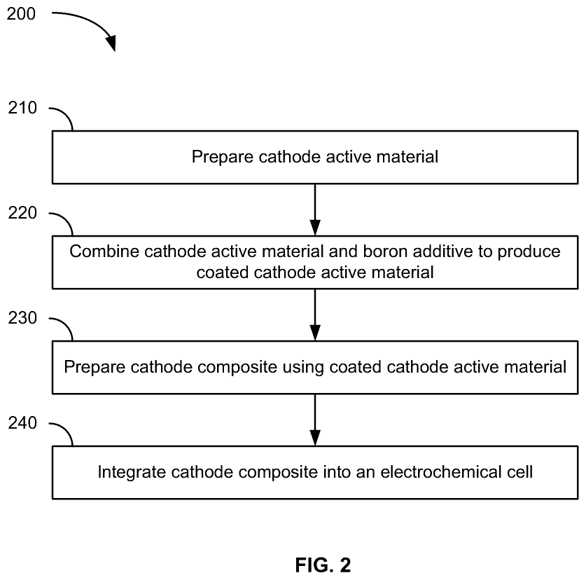

FIG. 2 shows a flow chart of a process for applying a boron additive to the surface of a cathode active material to form a coated cathode active material, incorporating the coated cathode active material into a cathode composite, and integrating the cathode composite into an electrochemical cell. Process 200 begins with step 210 in which the cathode active material is prepared to be combined with the boron additive. The preparing may include processes such as milling the cathode active material and sieving to remove agglomerates from the cathode active material. It should be noted that no particular surface treatment, such as cleaning or rinsing, of the cathode active material may be required. In some embodiments the cathode active material may already have a native coating on its surface, wherein the coating may comprise aluminum, zirconium, or niobium.

Next, during step 220, the cathode active material is combined with the boron additive. Combining the cathode active material and the boron additive may be performed for a period of time from about one minute to about 36 hours. The combining may be accomplished by mixing, stirring, tumbling, milling, or grinding. Once the boron additive is embedded in the surface of the cathode active material, the combining is accomplished and the mixing, stirring, tumbling, milling, or grinding may cease. Whether the boron additive is embedded in the surface of the cathode active material may be determined by SEM imaging, Fourier-transform infrared spectroscopy (FT-IR), Raman spectroscopy, scanning electron microscopy-energy dispersive x-ray spectroscopy (SEM-EDX), and other methods known in the art.

The boron additive may form platelets or layers on the surface of the cathode active material. The layers may cover only a portion of the surface of the cathode active material particles, or the layers may fully cover the surface of the cathode active material particles. Additionally, the layers may stack on top of one another as shown in FIG. 1. In other words, the boron additive may form a first layer on the surface of the cathode active material, and then additional boron additive may form a second layer on top of the first layer, and so on.

The thickness of each of the platelets or layers may be from about 1 nanometer to about 1 micron; for example, the thickness of the layer may be from about 1 nanometer to about 5 nanometers, about 1 nanometer to about 10 nanometers, about 1 nanometer to about 20 nanometers, about 1 nanometer to about 50 nanometers, about 1 nanometer to about 100 nanometers, about 1 nanometer to about 250 nanometers, about 1 nanometer to about 500 nanometers, about 1 nanometer to about 750 nanometers, about 1 nanometer to about 1 micron, about 5 nanometers to about 1 micron, about 10 nanometers to about 1 micron, about 20 nanometers to about 1 micron, about 50 nanometers to about 1 micron, about 100 nanometers to about 1 micron, about 250 nanometers to about 1 micron, about 500 nanometers to about 1 micron, or about 750 nanometers to about 1 micron. In some embodiments, the thickness may be from about 5 nanometers to about 750 nanometers. In another embodiment, the thickness may be from about 10 nanometers to about 500 nanometers. In a further embodiment, the thickness may be from about 15 nanometers to about 250 nanometers. In yet another embodiment, the thickness may be from about 17 nanometers to about 100 nanometers. In another embodiment, the thickness may be from about 20 nanometers to about 50 nanometers.

Once the coated cathode active material is formed, it may be incorporated into a cathode slurry. The cathode slurry may comprise the coated cathode active material and a solvent.

The cathode slurry may further comprise a binder. The binder may include fluororesin containing vinylidene fluoride (VdF), hexafluoropropylene (HFP), tetrafluoroethylene (TFE), and derivatives thereof as structural units. Specific examples thereof include such homopolymers as polyvinylidene fluoride (PVDF), polyhexafluoropropylene (PHFP), and polytetrafluoroethylene (PTFE), and binary copolymers such as copolymers of VdF and HFP such as poly(vinylene difluoride-hexafluoropropylene) copolymer (PVDF-HFP), and the like. In another embodiment, the binder may include a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, poly (methacrylate) nitrile-butadiene rubber (PMMA-NBR) and the like. In a further embodiment, the binder may include an acrylic resin such as but not limited to polymethyl (meth)acrylate, polyethyl (meth)acrylate, polyisopropyl (meth)acrylate polyisobutyl (meth)acrylate, polybutyl (meth)acrylate, and the like. In yet another embodiment, the binder may include a polycondensation polymer such as but not limited to polyurea, polyamide paper, polyimide, polyester, and the like. In yet a further embodiment, the binder may include a nitrile rubber such as but not limited to acrylonitrile-butadiene rubber (ABR), polystyrene nitrile-butadiene rubber (PS-NBR), and mixtures thereof.

Preferably, the binder includes a thermoplastic elastomer such as those comprising styrene and butadiene. For example, the binder may comprise styrene-butadiene-styrene copolymer (SBS), styrene-isoprene block copolymer (SIS), styrene-ethylene-butylene-styrene (SEBS), or combinations thereof.

In some embodiments, the binder may comprise a high molecular weight binder and a low molecular weight binder. The high molecular weight binder may be the same species of binder as the low molecular weight binder, or it may be different. The high molecular weight binder has a longer polymer chain compared to the low molecular weight binder. High molecular weight binders, as described herein, have a molecular weight of about 300,000 g/mol or higher. Low molecular weight binders, as described herein, have a molecular weight of about 100,000 or lower.

In embodiments wherein the cathode slurry comprises a high molecular weight binder and a low molecular weight binder, the high molecular weight binder and the low molecular weight binder may be present in a weight ratio from about 10:90 to about 90:10, such as from about 10:90 to about 20:80, about 10:90 to about 30:70, about 10:90 to about 40:60, about 10:90 to about 50:50, about 10:90 to about 60:40, about 10:90 to about 70:30, about 10:90 to about 80:20, about 10:90 to about 90:10, about 20:80 to about 90:10, about 30:70 to about 90:10, about 40:60 to about 90:10, about 50:50 to about 90:10, about 60:40 to about 90:10, about 70:30 to about 90:10, about 80:20 to about 90:10, about 20:80 to about 80:20, about 25:75 to about 75:25, or about 30:70 to about 70:30.

The binder may be present in the cathode slurry in an amount from about 1% to about 30% by weight of the cathode slurry. For example, the binder may be present in the cathode slurry in an amount from about 1% to about 5%, about 1% to about 10%, about 1% to about 15%, about 1% to about 20%, about 1% to about 25%, about 1% to about 30%, about 5% to about 30%, about 10% to about 30%, about 15% to about 30%, about 20% to about 30%, about 25% to about 30%, about 5% to about 15%, about 5% to about 20%, about 10% to about 15%, about 10% to about 20%, or about 15% to about 20% by weight of the cathode slurry.

The cathode slurry may further comprise a conductive additive. The conductive additive helps to evenly distribute the charge density throughout the cathode composite. The conductive additive may include metal powders, fibers, filaments, or any other material known to conduct electrons. The conductive additive may include a carbon-based conductive additive, such as carbon fiber, graphite, graphene, carbon black, conductive carbon, amorphous carbon, vapor grown carbon fiber (VGCF), carbon nanotubes, carbon nanowires, activated carbon, or any combination thereof.

In some embodiments, the conductive additive may be present in the cathode slurry in an amount from about 0% to about 15% by weight of the cathode slurry. In some aspects, the conductive additive may be present in the cathode slurry in an amount from about 0% to about 10%, or about 0% to about 5% by weight of the cathode slurry. In some additional aspects, the conductive additive may be present in the cathode slurry in an amount of about 0%, 1%, 2%, 3%, 4%, 5%, 6%, 7%, 8%, 9%, 10%, 11%, 12%, 13%, 14%, or about 15% by weight of the cathode slurry. In an example embodiment, the conductive additive is present in the cathode slurry in an amount from about 0% to about 5% by weight of the cathode slurry.

In some embodiments, the average particle size of the conductive additive may be from about 5 nm to about 1000 nm. In some aspects, the average particle size of the conductive additive may be about from 5 nm to about 100 nm, about 5 nm to about 200 nm, about 5 nm to about 300 nm, about 5 nm to about 400 nm, about 5 nm to about 500 nm, about 5 nm to about 600 nm, about 5 nm to about 700 nm, about 5 nm to about 800 nm, about 5 nm to about 900 nm, about 100 nm to about 1000 nm, about 200 nm to about 1000 nm, about 300 nm to about 1000 nm, about 400 nm to about 1000 nm, about 500 nm to about 1000 nm, about 600 nm to about 1000 nm, about 700 nm to about 1000 nm, about 800 nm to about 1000 nm, about 900 nm to about 1000 nm, about 100 nm to about 500 nm, or about 200 nm to about 400 nm. In some embodiments, the conductive additive may have an average particle size of about 5 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, or about 1000 nm. In some examples, the conductive additive may have an average particle size of about 30 nm. The average particle size (e.g., D₅₀) may be determined through any method known to those having ordinary skill in the art.

The cathode slurry further comprises a solid electrolyte. The solid electrolyte may include an oxide, oxysulfide, sulfide, halide, nitride, or any other solid electrolyte known in the art. In some preferred embodiments, the solid electrolyte may include a sulfide solid electrolyte, i.e., a solid electrolyte having at least one sulfur component. In some embodiments, solid electrolyte may include one or more material combinations such as Li₂S—P₂S₅, Li₂S—P₂S₅—LiI, Li₂S—P₂S₅—GeS₂, Li2_{S}—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂-LiₓMO_{y} (where x and y are positive numbers, and M is P, Si, Ge, B, Al, Ga or In). Halide solid electrolytes may have the structure Li-M-X, M is a metal element, and X is a halogen. These can be expressed by the generic formula Li_{α}M⁴⁺_{β}Z³⁺_{(1-β)}X_{Ω}Y_{(6-Ω)}, where: 0≤β≤1; 0≤Ω≤6; α=6−[(β*4)+ (1−β)*3]; X and Y are each independently a halogen such as F, Cl, Br, or I; M is an element having an oxidation state of 4+ such as Ti, Zr, Hf, and Rf; and Z is an element having an oxidation state of 3+ such as Ga, In, Tl, Sc, Y, Fe, Ru, Os, Er. Examples of halide electrolytes include Li₂ZrCl₆, Li₃InCl₆, and Li_{2.25}Hf_{0.75}Fe_{0.25}Cl₄Br₂.

In another embodiment, the solid electrolyte may include Li₃PS₄, Li₄P₂S₆, Li₇P₃S₁₁, Li₁₀GeP₂S₁₂, or Li₁₀SnP₂S₁₂. In a further embodiment, the solid electrolyte may include Li₆PS₅Cl, Li₆PS₅Br, Li₆PS₅I, or Li_{7-y}PS_{6-y}X_{y}, wherein “X” represents a halogen or a pseudo-halogen, 0<y≤2.0, the halogen may include F, Cl, Br, I, or any combination thereof, and the pseudo-halogen may include N, NH, NH₂, NO, NO₂, BF₄, BH₄, AlH₄, CN, SCN, or a combination thereof. In yet another embodiment, the solid electrolyte may be expressed by the formula Li_{8-y-z}P₂S_{9-y-z}X_{y}W_{z}, wherein “X” and “W” are each independently a halogen or a pseudo-halogen, wherein 0≤y≤1, 0≤z≤1, wherein the halogen may include F, Cl, Br, I, or any combination thereof, and the pseudo-halogen may include N, NH, NH₂, NO, NO₂, BF₄, BH₄, AlH₄, CN, SCN, or any combination thereof.

The solid electrolyte may be present in the slurry in an amount from greater than 0% to about 60% by weight; for example, the solid electrolyte may be present in the slurry in an amount from greater than 0% to about 10% by weight, greater than 0% to about 20% by weight, greater than 0% to about 30% by weight, greater than 0% to about 40% by weight, greater than 0% to about 50% by weight, about 10% to about 60% by weight, about 20% to about 60% by weight, about 30% to about 60% by weight, about 40% to about 60% by weight, or about 50% to about 60% by weight. In some aspects, the solid electrolyte may be present in the slurry in an amount of about 5%, 10%, 15%, 20%, 25%, 30%, 35%, 40%, 45%, 50%, 55%, or 60% by weight of the slurry. In an example embodiment, the solid electrolyte is present in the slurry in an amount from about 35% to about 45% by weight.

The solid electrolyte may have an average particle size from about 0.5 microns to about 50 microns, such as from about 0.5 microns to about 1 micron, about 0.5 microns to about 10 microns, about 0.5 microns to about 20 microns, about 0.5 microns to about 30 microns, about 0.5 microns to about 40 microns, about 0.5 microns to about 0.5 microns, about 1 micron to about 50 microns, about 10 microns to about 50 microns, about 20 microns to about 50 microns, about 30 microns to about 50 microns, or about 40 microns to about 50 microns.

The coated cathode active material may be present in the slurry in an amount from about 30% to about 98% by weight. In some aspects, the coated cathode active material may be present in the slurry in an amount of about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%, about 30% to about 85%, about 30% to about 90%, about 30% to about 95%, about 35% to about 98%, about 40% to about 98%, about 45% to about 98%, about 50% to about 98%, about 55% to about 98%, about 60% to about 98%, about 65% to about 98%, about 70% to about 98%, about 75% to about 98%, about 80% to about 98%, about 85% to about 98%, about 90% to about 98%, about 40% to about 90%, about 40% to about 80%, about 40% to about 70%, about 40% to about 60%, about 40% to about 55%, about 40% to about 50%, or about 40% to about 45% by weight.

In some embodiments, the slurry may comprise a secondary cathode active material. The secondary cathode active material is not coated with the boron additive, and may include nickel-manganese-cobalt (“NMC”) which can be expressed as Li(NiₐCo_{b}Mn_{c})O₂, wherein 0<a<1, 0<b<1, 0<c<1, and a+b+c=1. For example, the cathode active material may include NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂), or any combination thereof. In another embodiment, the cathode active material may comprise a coated or uncoated metal oxide, such as but not limited to V₂O₅, V₆O₁₃, MoO₃, LiCoO₂, LiNiO₂, LiMnO₂, LiMn₂O₄, LiNi_{1-Y}Co_{Y}O₂, LiCo_{1-Y}Mn_{Y}O₂, LiNi_{1-Y}Mn_{Y}O₂ (0≤Y<1), Li(NiₐCo_{b}Mn_{c})O₄ (0<a<2, 0<b<2, 0<c<2, a+b+c=2), LiMn_{2-Z}Ni_{Z}O₄, LiMn_{2-Z}Co_{Z}O₄ (0<Z<2), LiCoPO₄, LiFePO₄, CuO, Li(NiₐCo_{b}Al_{c})O₂ (0<a<1, 0<b<1, 0<c<1, a+b+c=1), or any combination thereof. In yet another embodiment, the secondary cathode active material may comprise a coated or uncoated metal sulfide such as but not limited to titanium sulfide (TiS₂), molybdenum sulfide (MoS₂), iron sulfide (FeS, FeS₂), copper sulfide (CuS), and nickel sulfide (Ni₃S₂), or any combination thereof. In still further embodiments, the secondary cathode active material may comprise elemental sulfur(S). In additional embodiments, the secondary cathode active material may comprise a fluoride cathode active material such as but not limited to lithium fluoride (LiF), sodium fluoride (NaF), calcium fluoride (CaF₂), magnesium fluoride (MgF₂), nickel (II) fluoride (NiF₂), iron (III) fluoride (FeF₃), vanadium (III) fluoride (VF₃), cobalt (III) fluoride (CoF₃), chromium (III) fluoride (CrF₃), manganese (III) fluoride (MnF₃), aluminum fluoride (AlF₃), and zirconium (IV) fluoride (ZrF₄), or any combination thereof.

The cathode slurry may have a solids content from about 10% to less than 100%. For example, the cathode slurry may have a solids content from about 10% to about 20%, about 10% to about 30%, about 10% to about 40%, about 10% to about 50%, about 10% to about 60%, about 10% to about 70%, about 10% to about 80%, about 10% to about 90%, about 10% to less than 100%, about 20% to less than 100%, about 30% to less than 100%, about 40% to less than 100%, about 50% to less than 100%, about 60% to less than 100%, about 70% to less than 100%, about 80% to less than 100%, about 90% to less than 100%, about 50% to about 90%, about 60% to about 90%, or about 70% to about 90%.

The cathode slurry may have a viscosity from about 20 cP to about 3000 cP measured at a shear rate of about 100 s⁻¹. For example, the cathode slurry may have a viscosity form about 20 cP to about 100 cP, about 20 cP to about 500 cP, about 20 cP to about 1000 cP, about 20 cP to about 1500 cP, about 20 cP to about 2000 cP, about 20 cP to about 2500 cP, about 20 cP to about 3000 cP, about 100 cP to about 3000 cP, about 500 cP to about 3000 cP, about 1000 cP to about 3000 cP, about 1500 cP to about 3000 cP, about 2000 cP to about 3000 cP, or about 2500 cP to about 3000 cP. In some embodiments, the cathode slurry may have a viscosity of about 20 cP, 50 cP, 100 cP, 150 cP, 200 cP, 250 cP, 300 cP, 350 cP, 400 cP, 450 cP, 500 cP, 550 cP, 600 cP, 650 cP, 700 cP, 750 cP, 800 cP, 850 cP, 900 cP, 950 cP, 1000 cP, 1100 cP, 1200 cP, 1300 cP, 1400 cP, 1500 cP, 1600 cP, 1700 cP, 1800 cP, 1900 cP, 2000 cP, 2100 cP, 2200 cP, 2300 cP, 2400 cP, 2500 cP, 2600 cP, 2700 cP, 2800 cP, 2900 cP, or about 3000 cP measured at a shear rate of about 100 s⁻¹.

The solvent used in the cathode slurry may include an ester solvent or a hydrocarbon solvent. All of the materials contained in the cathode slurry may be mixed to form a homogeneous slurry. Methods of combining and mixing are generally known to those having ordinary skill in the art. The ester solvent may include ethyl acetate, ethyl butyrate, isobutyl acetate, butyl acetate, butyl butyrate and butyl propanoate. The hydrocarbon solvent may include an alkane, a blend of alkanes, xylene (including para-, meta-, and ortho-xylene), toluene, benzene, heptane, octane, decalin, 1,2,3,4-tetrahydronaphthalene, or combinations thereof. The blend of alkanes may include alkane solvents including from 4 to 20 carbon atoms.

The cathode slurry may then be coated onto a substrate. The substrate may comprise a carrier foil, a current collector, a dried electrochemical cell layer, or another substrate. The coating may be accomplished by pouring the slurry onto a substrate via gravity or by pumping the slurry onto the substrate. The process may take place in ambient conditions, or may take place in an inert atmosphere such as nitrogen or argon. In some embodiments, the process may be conducted in an atmosphere comprising air and moisture. In other embodiments, the process may be conducted in an atmosphere comprising air and substantially no moisture (i.e., less than 1% humidity).

The slurry may be coated onto the substrate at ambient temperature and pressure. In some aspects, the slurry may be coated onto the surface at a temperature up to the boiling point of the solvent used in the slurry, or the slurry may be coated at cooler temperatures to limit vaporization of the solvent.

Once coated, a cathode composite is formed. The solvent may be removed from the cathode composite by drying the coated slurry to form a dried composition including a cathode layer for use in an electrochemical cell. The drying may occur at a temperature from about 15° C. to about 300° C. For example, the drying may occur at a temperature from about 15° C. to about 30° C., about 15° C. to about 50° C., about 15° C. to about 100° C., about 15° C. to about 150° C., about 15° C. to about 200° C., about 15° C. to about 250° C., about 15° C. to about 300° C., about 30° C. to about 300° C., about 50° C. to about 300° C., about 100° C. to about 300° C., about 150° C. to about 300° C., about 200° C. to about 300° C., or about 250° C. to about 300° C. In some embodiments, the drying may occur at a temperature of about 15° C., 20° C., 25° C., 30° C., 35° C., 40° C., 45° C., 50° C., 60° C., 70° C., 80° C., 90° C., 100° C., 125° C., 150° C., 175° C., 200° C., 225° C., 250° C., 275° C., or about 300° C.

After the drying is completed, the amount of solvent left in the dried composition may range from 0.01% to 0% by weight of the dried composition. Preferably the amount of solvent in the dried composition is minimized. If a substantial amount of solvent remains in the dried composition, the electrochemical performance of an electrochemical cell containing the dried composite may be negatively affected.

Further processing may include densifying the dried composition. The composition may be densified through densification processes known to those having ordinary skill in the art, such as calendaring, linear densification, compaction, or compression. In preferred embodiments, the densifying may be accomplished via calendaring, forming a densified cathode composite layer to be incorporated into an electrochemical cell.

The dried composition may have a density after densification from about 50% to about 99% of the theoretical density of the composition. The theoretical density is defined as the maximum density of the composition that could be achieved assuming there are no voids or contaminants. The density may be from about 50% to about 60%, about 50% to about 70%, about 50% to about 80%, about 50% to about 90%, about 50% to about 95%, about 50% to about 99%, about 60% to about 99%, about 70% to about 99%, about 80% to about 99%, about 90% to about 99%, or about 95% to about 99% of the theoretical density of the dried composition.

The dried composition may have a porosity from about 1% to about 70%. For example, the dried composition may have a porosity from about 1% to about 10%, about 1% to about 20%, about 1% to about 30%, about 1% to about 40%, about 1% to about 50%, about 1% to about 60%, about 1% to about 70%, about 10% to about 70%, about 20% to about 70%, about 30% to about 70%, about 40% to about 70%, about 50% to about 70%, or about 60% to about 70%. The porosity of the dried composition may be measured through techniques known in the art, such as through SEM imaging, TEM imaging, FIB-SEM imaging, confocal microscopy, gas adsorption, mercury porosimetry, helium pycnometry, or other methods known in the art.

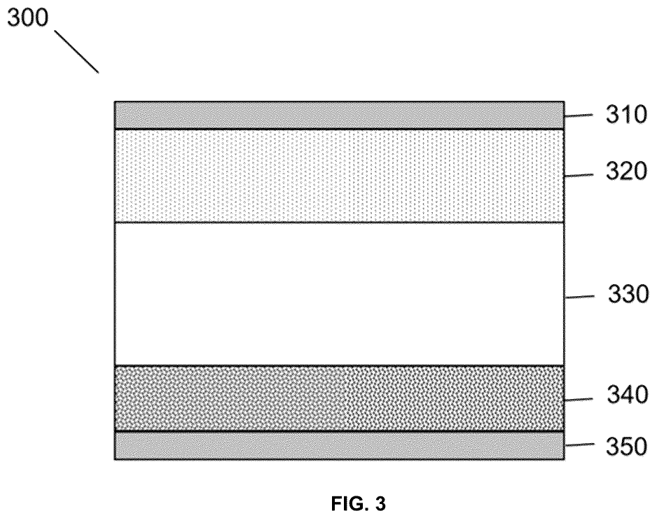

FIG. 3 is a schematic cross-sectional view of an example electrochemical cell including the coated cathode active material used in the construction of an electrochemical cell. Solid-state electrochemical cell 300 includes a positive electrode current collector 310, a positive electrode (cathode) 320, a separator (solid electrolyte layer) 330, a negative electrode (anode) 340, and a negative electrode current collector 350. The positive electrode 320 may be positioned between the positive electrode current collector 310 and the separator 330. The negative electrode 340 may be positioned between the negative electrode current collector 350 and the separator 330. The positive electrode current collector 310 electrically contacts the positive electrode 320, and the negative electrode current collector 350 electrically contacts the negative electrode 340.

The positive electrode current collector 310 is in electrical communication with the positive electrode 320 and may be formed from materials including, but not limited to, Aluminum (Al), Nickel (Ni), Titanium (Ti), Stainless Steel, Magnesium (Mg), Iron (Fe), Zinc (Zn), Indium (In), Germanium (Ge), Silver (Ag), Platinum (Pt), Gold (Au), Lithium (Li), or alloys thereof. In some embodiments, the positive electrode current collector 310 may be formed from one or more carbon-containing materials such as carbon fiber, graphite, graphene, carbon black, conductive carbon, amorphous carbon, VGCF, or carbon nanotubes. Similarly, the negative electrode current collector 350 is in electrical communication with the negative electrode 340 and may be formed from materials including, but not limited to, Aluminum (Al), Nickel (Ni), Titanium (Ti), Stainless Steel, Magnesium (Mg), Iron (Fe), Zinc (Zn), Indium (In), Germanium (Ge), Silver (Ag), Platinum (Pt), Gold (Au), Lithium (Li), or alloys thereof. In some embodiments, the negative electrode current collector 350 may be formed from one or more carbon-containing materials such as carbon fiber, graphite, graphene, carbon black, conductive carbon, amorphous carbon, VGCF, and carbon nanotubes.

The positive electrode 320 includes a cathode active material. The cathode active material may be any cathode active material or secondary cathode active material described herein.

The positive electrode 320 may further include a solid electrolyte material. The solid electrolyte material may comprise an oxide, oxysulfide, sulfide, halide, nitride, or any other solid electrolyte known in the art. In some preferred embodiments, the solid electrolyte material may comprise a sulfide solid electrolyte material, i.e., a solid electrolyte having at least one sulfur component. In some embodiments, the solid electrolytes may comprise one or more material combinations such as Li₂S—P₂S₅, Li₂S—P₂S₅—LiI, Li₂S—P₂S₅—GeS₂, Li2_{S}—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂-LiₓMO_{y} (where x and y are positive numbers, and M is P, Si, Ge, B, Al, Ga or In). Halide solid electrolytes may have the structure Li-M-X, M is a metal element, and X is a halogen. These can be expressed by the generic formula Li_{α}M⁴⁺_{β}N³⁺_{(1-β)}X_{Ω}Y_{(6-Ω)}, where: 0<β<1; 0<Ω<6; α=6−[(β+4)+ (1−β)*3]; X and Y are a halogen such as F, Cl, Br, I; M is an element with an oxidation state of 4+ such as Ti, Zr, Hf, and Rf; and N is an element an oxidation state of 3+ such as Ga, In, and Ti, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

In another embodiment, the solid electrolyte material may include Li₃PS₄, Li₄P₂S₆, Li₇P₃S₁₁, Li₁₀GeP₂S₁₂, Li₁₀SnP₂S₁₂. In a further embodiment, the solid electrolyte material may include Li₆PS₅Cl, Li₆PS₅Br, Li₆PS₅I or may be expressed by the formula Li_{7-y}PS_{6-y}X_{y} where “X” represents at least one halogen and/or at least one pseudo-halogen, and where 0<y≤2.0 and where the halogen may be one or more of F, Cl, Br, I, and the pseudo-halogen may be one or more of N, NH, NH₂, NO, NO₂, BF₄, BH₄, AlH₄, CN, and SCN. In yet another embodiment, the solid electrolyte material may be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, Cl, Br, I, and the pseudo-halogen may be one or more of N, NH, NH₂, NO, NO₂, BF₄, BH₄, AlH₄, CN, and SCN.

The positive electrode 320 may further include a binder. The binder may include a fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVDF), polyhexafluoropropylene (PHFP), and polytetrafluoroethylene (PTFE), and binary copolymers such as copolymers of VdF and HFP such as poly(vinylene difluoride-hexafluoropropylene) copolymer (PVDF-HFP), and the like. In another embodiment, the binder may include a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, Poly (methacrylate) nitrile-butadiene rubber (PMMA-NBR) and the like. In yet another embodiment, the binder may include a polycondensation polymer such as but not limited to polyurea, polyamide paper, polyimide, polyester, and the like. In yet a further embodiment, the binder may include a nitrile rubber such as but not limited to acrylonitrile-butadiene rubber (ABR), polystyrene nitrile-butadiene rubber (PS-NBR), or mixtures thereof.

The binder may comprise a high molecular weight binder and a low molecular weight binder. The high molecular weight binder may be the same species of binder as the low molecular weight binder, or it may be different. The high molecular weight binder has a longer polymer chain as compared to the low molecular weight binder. High molecular weight binders, as described herein, have a molecular weight of about 300,000 g/mol or higher. Low molecular weight binders, as described herein, have a molecular weight of about 100,000 g/mol or lower.

The positive electrode 320 may further include a conductive additive. The conductive additive may be a carbon-based material. For example, the conductive additive may include graphite, carbon black, graphene, VGCF, amorphous carbon, or any combination thereof.

The separator 330 may include a solid electrolyte material and a binder. The solid electrolyte material may include any solid electrolyte material described herein.

The binder may be any binder described hereinabove. The binder may comprise a high molecular weight binder and a low molecular weight binder. The high molecular weight binder may be the same species of binder as the low molecular weight binder, or it may be different. The high molecular weight binder has a longer polymer chain as compared to the low molecular weight binder. High molecular weight binders, as described herein, have a molecular weight of about 300,000 g/mol or higher. Low molecular weight binders, as described herein, have a molecular weight of about 100,000 g/mol or lower.

The negative electrode 340 includes an anode active material. The anode active material preferably is an inorganic material. The anode active material may include one or more inorganic materials such as silicon (Si), silicon alloys, tin (Sn), tin alloys, germanium (Ge), germanium alloys, graphite, Li₄Ti₅O₁₂ (LTO), other known anode active materials, or any combination thereof.

The negative electrode 340 may further include a solid electrolyte material. The solid electrolyte material may include any solid electrolyte material described herein, including a multi-layer surface-modified solid electrolyte material.

The negative electrode 340 may further include a binder. The binder may be any binder described hereinabove. The binder may comprise a high molecular weight binder and a low molecular weight binder. The high molecular weight binder may be the same species of binder as the low molecular weight binder, or it may be different. The high molecular weight binder has a longer polymer chain as compared to the low molecular weight binder. High molecular weight binders, as described herein, have a molecular weight of about 300,000 g/mol or higher. Low molecular weight binders, as described herein, have a molecular weight of about 100,000 g/mol or lower.

The negative electrode 340 may further include a conductive additive. The conductive additive may be any conductive additive discussed hereinabove.

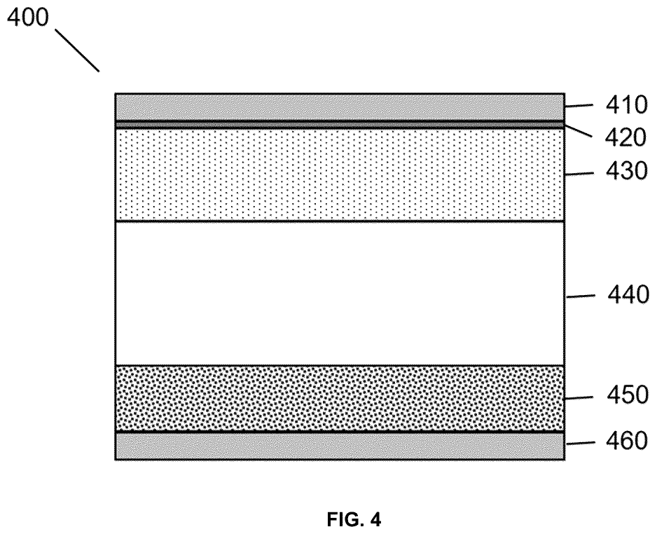

FIG. 4 is a schematic cross-sectional view of an example of a solid-state electrochemical cell 400 including a boron additive-containing layer 420. The boron additive-containing layer 420 may act as a thermal barrier and an oxygen scavenging layer. For example, when the boron additive includes boron nitride, the boron nitride reacts with oxygen to form B₂O₃ and NOₓ the carbon forms CO and CO₂. Solid-state electrochemical cell 400 includes a positive electrode current collector 410, a boron additive-containing layer 420, a positive electrode (cathode) 430, a separator (solid electrolyte layer) 440, a negative electrode (anode) 450, and a negative electrode current collector 460. The positive electrode 430 is positioned between the boron additive-containing layer 420 and the separator 440. The negative electrode 450 may be positioned between negative electrode current collector 460 and the separator 440. The positive electrode current collector 410 electrically contacts the boron additive-containing layer 420. The negative electrode current collector 460 electrically contacts the negative electrode 450.

The positive electrode current collector 410 is in electrical communication with the boron additive-containing layer 420 and may be formed from materials including, but not limited to, Aluminum (Al), Nickel (Ni), Titanium (Ti), Stainless Steel, Magnesium (Mg), Iron (Fe), Zinc (Zn), Indium (In), Germanium (Ge), Silver (Ag), Platinum (Pt), Gold (Au), Lithium (Li), or alloys thereof. In some embodiments, the positive electrode current collector 410 may be formed from one or more carbon-containing materials such as carbon fiber, graphite, graphene, carbon black, conductive carbon, amorphous carbon, VGCF, and carbon nanotubes. Similarly, the negative electrode current collector 460 is in electrical communication with the negative electrode 450 and may be formed from materials including, but not limited to, Aluminum (Al), Nickel (Ni), Titanium (Ti), Stainless Steel, Magnesium (Mg), Iron (Fe), Zinc (Zn), Indium (In), Germanium (Ge), Silver (Ag), Platinum (Pt), Gold (Au), Lithium (Li), or alloys thereof. In some embodiments, the negative electrode current collector 460 may be formed from one or more carbon containing materials such as carbon fiber, graphite, graphene, carbon black, conductive carbon, amorphous carbon, VGCF, and carbon nanotubes.

The boron additive-containing layer 420 may be formed by combining a boron additive with an electrically conductive material. The electrically conductive material may include metal powders, fibers, filaments, or any other material known to conduct electrons. Combining the boron additive and the electrically conductive material may be performed for a period of time from about one minute to about 36 hours, or until the boron additive and the electrically conductive material are well-combined as may be determined by a visual inspection. In some embodiments, the boron additive and the electrically conductive material may be combined in the presence of a solvent to form a slurry. The combining may be accomplished by mixing, stirring, tumbling, milling, or grinding. The combined boron additive and electrically conductive material may then be coated onto a current collector to form the boron-additive containing layer. In embodiments in which a solvent is used, the coated layer may be dried to remove the solvent.

The boron additive may include boron nitride, elemental boron, boron oxide (B₂O₃), H₃BO₃, Zn₃B₂O₆, B₄C, or a combination thereof. In an exemplary embodiment, the boron additive may include boron nitride.

In some embodiments, the boron additive may include boron nitride and at least one additional boron-containing material. The weight ratio of the boron additive to the at least one additional boron-containing material in the boron additive-containing layer may be greater than 50%. For example, the weight ratio of the boron additive to the at least one additional boron-containing material in the boron additive-containing layer may be greater than 50%, greater than 60%, greater than 70%, greater than 80%, or greater than 90%. As another example, the weight ratio of the boron additive to the at least one additional boron-containing material in the boron additive-containing layer may be from about 50% to about 60%, about 50% to about 70%, about 50% to about 80%, about 50% to about 90%, about 50% to about 99%, about 60% to about 99%, about 70% to about 99%, about 80% to about 99%, about 90% to about 99%, or about 95% to about 99%.

In some embodiments, the boron additive may be present in the boron additive-containing layer in an amount from about 20% to about 80% by weight. In some aspects, the boron additive may be present in the boron additive-containing layer in an amount from about 20% to about 80%, or about 30% to about 80% by weight of the boron additive-containing layer. In some additional aspects, the boron additive may be present in the boron additive-containing layer in an amount of about 20%, 30%, 40%, 50%, 60%, 70%, 80%, 25%, 35%, 45%, 55%, 65%, 75%, 27%, or about 57% by weight.

In some embodiments, the average particle size of the boron additive may be from about 1 nm to about 1000 nm. In some aspects, the average particle size of the boron additive may be about from 1 nm to about 100 nm, about 1 nm to about 200 nm, about 1 nm to about 300 nm, about 1 nm to about 400 nm, about 1 nm to about 500 nm, about 1 nm to about 600 nm, about 1 nm to about 700 nm, about 1 nm to about 800 nm, about 1 nm to about 900 nm, about 10 nm to about 1000 nm, about 20 nm to about 1000 nm, about 10 nm to about 1000 nm, about 100 nm to about 1000 nm, about 200 nm to about 1000 nm, about 300 nm to about 1000 nm, about 400 nm to about 1000 nm, about 500 nm to about 1000 nm, about 600 nm to about 1000 nm, about 100 nm to about 500 nm, or about 200 nm to about 400 nm. In some embodiments, the boron additive may have a particle size of about 5 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, or about 1000 nm. In some examples, the boron additive may have an average particle size of about 50 nm. The average particle size (e.g., D₅₀) may be determined through any method known to those having ordinary skill in the art.

The electrically conductive material helps to evenly distribute the charge density throughout the boron additive containing layer 420, as the boron additive may lack the desired electrically conductivity. The electrically conductive material may include metal powders, fibers, filaments, or any other material known to conduct electrons. The electrically conductive additive may comprise a carbon-based conductive additive, such as carbon fiber, graphite, graphene, carbon black, conductive carbon, amorphous carbon, vapor grown carbon fiber (VGCF), carbon nanotubes, carbon nanowires, activated carbon, and combinations thereof.

In some embodiments, the electrically conductive additive may be present in the boron additive-containing layer in an amount from about 20% to about 80% by weight of the boron additive-containing layer. In some aspects, the electrically conductive additive may be present in the slurry in an amount from about 20% to about 80%, or about 30% to about 80% by weight. In some additional aspects, the conductive additive may be present in the slurry in an amount of about 20%, 30%, 40%, 50%, 60%, 70%, 80%, 25%, 35%, 45%, 55%, 65%, 75%, 27%, or about 57% by weight.

In some embodiments, the average particle size of the electrically conductive additive may be from about 5 nm to about 1000 nm. In some aspects, the average particle size of the electrically conductive additive may be about from 5 nm to about 100 nm, about 5 nm to about 200 nm, about 5 nm to about 300 nm, about 5 nm to about 400 nm, about 5 nm to about 500 nm, about 5 nm to about 600 nm, about 5 nm to about 700 nm, about 5 nm to about 800 nm, about 5 nm to about 900 nm, about 100 nm to about 1000 nm, about 200 nm to about 1000 nm, about 300 nm to about 1000 nm, about 400 nm to about 1000 nm, about 500 nm to about 1000 nm, about 600 nm to about 1000 nm, about 700 nm to about 1000 nm, about 800 nm to about 1000 nm, about 900 nm to about 1000 nm, about 100 nm to about 500 nm, or about 200 nm to about 400 nm. In some embodiments, the electrically conductive additive may have a particle size of about 5 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, or about 1000 nm. In some examples, the electrically conductive additive may have an average particle size of about 30 nm. The average particle size (e.g., D₅₀) may be determined through any method known to those having ordinary skill in the art.

The boron additive-containing layer 420 may further comprise a binder. The binder may include fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVDF), polyhexafluoropropylene (PHFP), and polytetrafluoroethylene (PTFE), and binary copolymers such as copolymers of VdF and HFP such as poly(vinylene difluoride-hexafluoropropylene) copolymer (PVDF-HFP), and the like. In another embodiment, the binder may include a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, Poly (methacrylate) nitrile-butadiene rubber (PMMA-NBR), and the like. In a further embodiment, the binder may include an acrylic resin such as but not limited to polymethyl (meth)acrylate, polyethyl (meth)acrylate, polyisopropyl (meth)acrylate polyisobutyl (meth)acrylate, polybutyl (meth)acrylate, and the like. In yet another embodiment, the binder may include a polycondensation polymer such as but not limited to polyurea, polyamide paper, polyimide, polyester, and the like. In yet a further embodiment, the binder may include a nitrile rubber such as but not limited to acrylonitrile-butadiene rubber (ABR), polystyrene nitrile-butadiene rubber (PS-NBR), and mixtures thereof.

The binder may be present in the boron additive-containing layer 420 in an amount from about 1% to about 30% by weight of the boron additive-containing layer. For example, the binder may be present in the boron additive-containing in an amount from about 1% to about 5%, about 1% to about 10%, about 1% to about 15%, about 1% to about 20%, about 1% to about 25%, about 1% to about 30%, about 5% to about 30%, about 10% to about 30%, about 15% to about 30%, about 20% to about 30%, about 25% to about 30%, about 5% to about 15%, about 5% to about 20%, about 10% to about 15%, about 10% to about 20%, or about 15% to about 20% by weight of the boron additive-containing layer.

The thickness of the boron additive-containing layer 420 may be between 500 nm to 10 μm. For example, the boron additive-containing layer 420 may have a thickness from about 500 nm to about 1 μm, about 500 nm to about 2.5 μm, about 500 nm to about 5 μm, about 500 nm to about 7.5 μm, about 500 nm to about 10 μm, about 1 μm to about 10 μm, about 2.5 μm to about 10 μm, about 5 μm to about 10 μm, about 7.5 μm to about 10 μm, or about 1 μm to about 5 μm. As another example, the boron additive-containing layer 420 may have a thickness of about 500 nm, 600 nm, 700 nm, 800 nm, 900 nm, 1 μm, 2 μm, 3 μm, 4 μm, 5 μm, 6 μm, 7 μm, 8 μm, 9 μm, or about 10 μm.

The boron additive-containing layer may have a porosity from about 5% to about 50%. For example, the boron additive-containing layer may have a porosity from about 5% to about 10%, about 5% to about 20%, about 5% to about 30%, about 5% to about 40%, about 5% to about 50%, about 10% to about 50%, about 20% to about 50%, about 30% to about 50%, about 40% to about 50%, or about 20% to about 40%. As another example, the boron additive-containing layer may have a porosity of about 5%, 10%, 15%, 20%, 25%, 30%, 35%, 40%, 45%, or about 50%.

The positive electrode 430 includes a cathode active material. The cathode active material may be any cathode active material or secondary cathode active material described herein.

The positive electrode 430 may further include a solid electrolyte material. The solid electrolyte material may comprise an oxide, oxysulfide, sulfide, halide, nitride, or any other solid electrolyte known in the art. In some preferred embodiments, the solid electrolyte material may comprise a sulfide solid electrolyte material, i.e., a solid electrolyte having at least one sulfur component. In some embodiments, the solid electrolytes may comprise one or more material combinations such as Li₂S—P₂S₅, Li₂S—P₂S₅—LiI, Li₂S—P₂S₅—GeS₂, Li2_{S}—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂-LiₓMO_{y} (where x and y are positive numbers, and M is P, Si, Ge, B, Al, Ga or In). Halide solid electrolytes may have the structure Li-M-X, M is a metal element, and X is a halogen. These can be expressed by the generic formula Li_{α}M⁴⁺_{βN}³⁺_{(1-β)}X_{Ω}Y_{(6-Ω)}, where: 0≤β≤1; 0≤Ω≤6; α=6−[(β*4)+(1−β)*3]; X and Y are a halogen such as F, Cl, Br, I; M is an element with an oxidation state of 4+ such as Ti, Zr, Hf, and Rf; and N is an element an oxidation state of 3+ such as Ga, In, and Ti, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

In another embodiment, the solid electrolyte material may include Li₃PS₄, Li₄P₂S₆, Li₇P₃S₁₁, Li₁₀GeP₂S₁₂, Li₁₀SnP₂S₁₂. In a further embodiment, the solid electrolyte material may include Li₆PS₅Cl, Li₆PS₅Br, Li₆PS₅I or may be expressed by the formula Li_{7-y}PS_{6-y}X_{y} where “X” represents at least one halogen and/or at least one pseudo-halogen, and where 0<y≤2.0 and where the halogen may be one or more of F, Cl, Br, I, and the pseudo-halogen may be one or more of N, NH, NH₂, NO, NO₂, BF₄, BH₄, AlH₄, CN, and SCN. In yet another embodiment, the solid electrolyte material may be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, Cl, Br, I, and the pseudo-halogen may be one or more of N, NH, NH₂, NO, NO₂, BF₄, BH₄, AlH₄, CN, and SCN.

The positive electrode 430 may further include a binder. The binder may include a fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVDF), polyhexafluoropropylene (PHFP), and polytetrafluoroethylene (PTFE), and binary copolymers such as copolymers of VdF and HFP such as poly(vinylene difluoride-hexafluoropropylene) copolymer (PVDF-HFP), and the like. In another embodiment, the binder may include a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, Poly (methacrylate) nitrile-butadiene rubber (PMMA-NBR) and the like. In yet another embodiment, the binder may include a polycondensation polymer such as but not limited to polyurea, polyamide paper, polyimide, polyester, and the like. In yet a further embodiment, the binder may include a nitrile rubber such as but not limited to acrylonitrile-butadiene rubber (ABR), polystyrene nitrile-butadiene rubber (PS-NBR), or mixtures thereof.

The binder may comprise a high molecular weight binder and a low molecular weight binder. The high molecular weight binder may be the same species of binder as the low molecular weight binder, or it may be different. The high molecular weight binder has a longer polymer chain as compared to the low molecular weight binder. High molecular weight binders, as described herein, have a molecular weight of about 300,000 g/mol or higher. Low molecular weight binders, as described herein, have a molecular weight of about 100,000 g/mol or lower.

The positive electrode 430 may further include a conductive additive. The conductive additive may be a carbon-based material. For example, the conductive additive may include graphite, carbon black, graphene, VGCF, amorphous carbon, or any combination thereof.

The separator 440 may include a solid electrolyte material and a binder. The solid electrolyte material may include any solid electrolyte material described herein.

The binder may be any binder described hereinabove. The binder may comprise a high molecular weight binder and a low molecular weight binder. The high molecular weight binder may be the same species of binder as the low molecular weight binder, or it may be different. The high molecular weight binder has a longer polymer chain as compared to the low molecular weight binder. High molecular weight binders, as described herein, have a molecular weight of about 300,000 g/mol or higher. Low molecular weight binders, as described herein, have a molecular weight of about 100,000 g/mol or lower.

The negative electrode 450 includes an anode active material. The anode active material preferably is an inorganic material. The anode active material may include one or more inorganic materials such as silicon (Si), silicon alloys, tin (Sn), tin alloys, germanium (Ge), germanium alloys, graphite, Li₄Ti₅O₁₂ (LTO), other known anode active materials, or any combination thereof.

The negative electrode 450 may further include a solid electrolyte material. The solid electrolyte material may include any solid electrolyte material described herein, including a multi-layer surface-modified solid electrolyte material.

The negative electrode 450 may further include a binder. The binder may be any binder described hereinabove. The binder may comprise a high molecular weight binder and a low molecular weight binder. The high molecular weight binder may be the same species of binder as the low molecular weight binder, or it may be different. The high molecular weight binder has a longer polymer chain as compared to the low molecular weight binder. High molecular weight binders, as described herein, have a molecular weight of about 300,000 g/mol or higher. Low molecular weight binders, as described herein, have a molecular weight of about 100,000 g/mol or lower.

The negative electrode 450 may further include a conductive additive. The conductive additive may be any conductive additive discussed hereinabove.

What is claimed is:

1. A composition comprising a boron additive and a cathode active material having a surface, wherein the boron additive is in physical contact with the surface of the cathode active material.

2. The composition of claim 1, wherein the cathode active material comprises LiNiₐMn_{b}Co_{c}O₂, wherein 0<a<1, 0<b<1, 0<c<1 and a+b+c=1.

3. The composition of claim 1, wherein the boron additive comprises boron nitride, elemental boron, boron oxide (B₂O₃), H₃BO₃, Zn₃B₂O₆, or B₄C.

4. The composition of claim 1, further comprising a conductive additive, wherein the conductive additive includes carbon fiber, graphite, graphene, carbon black, conductive carbon, amorphous carbon, VGCF, or carbon nanotubes.

5. The composition of claim 1, further comprising a binder, wherein the binder comprises styrene-butadiene rubber (SBR), styrene-butadiene-styrene copolymer (SBS), styrene-isoprene block copolymer (SIS), or styrene-ethylene-butylene-styrene (SEBS).

6. The composition of claim 1, further comprising a solid electrolyte, wherein the solid electrolyte comprises Li_{7-y}PS_{6-y}X_{y}, wherein “X” represents a halogen, a pseudo-halogen, or a combination thereof; 0<y≤2.0; the halogen includes F, Cl, Br, I, or a combination thereof, and the pseudo-halogen includes N, NH, NH₂, NO, NO₂, BF₄, BH₄, AlH₄, CN, SCN, or a combination thereof.

7. An electrochemical cell comprising:
a first current collector layer;
a cathode layer;
a boron additive-containing layer comprising a boron additive and having a thickness from about 0.5 μm to about 15 μm, wherein the boron layer is positioned between the first current collector layer and the cathode layer;
a separator layer;
an anode layer; and
a second current collector layer.

8. The electrochemical cell of claim 7, wherein the boron additive-containing layer comprises boron nitride, elemental boron, boron oxide (B₂O₃), H₃BO₃, Zn₃B₂O₆, or B₄C.

9. The electrochemical cell of claim 7, wherein the boron additive-containing layer further comprises carbon fiber, graphite, graphene, carbon black, conductive carbon, amorphous carbon, VGCF, or carbon nanotubes.

10. The electrochemical cell of claim 7, wherein the boron additive-containing layer comprises boron nitride and at least one additional boron-containing material, and the weight ratio of boron nitride to the at least one additional boron-containing material in the boron layer is greater than 50%.

11. The electrochemical cell of claim 7, wherein the cathode layer comprises LiNiₐMn_{b}Co_{c}O₂, where 0<a<1, 0<b<1, 0<c<1, and a+b+c=1.

12. The electrochemical cell of claim 7, wherein the separator layer comprises a solid electrolyte material which can be expressed as Li_{7-y}PS_{6-y}X_{y} where “X” represents at least one halogen and/or at least one pseudo-halogen, and where 0<y≤2.0 and where the halogen may be one or more of F, Cl, Br, I, and the pseudo-halogen may be one or more of N, NH, NH₂, NO, NO₂, BF₄, BH₄, AlH₄, CN, and SCN.

13. The electrochemical cell of claim 7, wherein the anode layer comprises silicon, lithium, carbon, magnesium, indium, gallium, aluminum, calcium, silver, or tin.

14. The electrochemical cell of claim 7, wherein the second current collector is in electrical communication with the anode layer.

15. An electrochemical cell comprising:
a first current collector layer;
a cathode layer comprising a boron additive and a cathode active material having a surface, wherein the boron additive is in physical contact with the surface of the cathode active material, wherein the cathode layer is in electrical communication with the first current collector layer;
a separator layer;
an anode layer; and
a second current collector layer, wherein the second current collector layer is in electrical communication with the anode layer.

16. The electrochemical cell of claim 15, wherein the cathode active material comprises LiNiₐMn_{b}Co_{c}O₂, wherein 0<a<1, 0<b<1, 0<c<1 and a+b+c=1.

17. The electrochemical cell of claim 15, wherein the boron additive comprises boron nitride, elemental boron, boron oxide (B₂O₃), H₃BO₃, Zn₃B₂O₆, or B₄C.

18. The electrochemical cell of claim 15, wherein the cathode layer further comprising a conductive additive, wherein the conductive additive includes carbon fiber, graphite, graphene, carbon black, conductive carbon, amorphous carbon, VGCF, or carbon nanotubes.

19. The electrochemical cell of claim 15, wherein the cathode layer further comprises a solid electrolyte, wherein the solid electrolyte comprises Li_{7-y}PS_{6-y}X_{y}, wherein “X” represents a halogen, a pseudo-halogen, or a combination thereof; 0<y≤2.0; the halogen includes F, Cl, Br, I, or a combination thereof, and the pseudo-halogen includes N, NH, NH₂, NO, NO₂, BF₄, BH₄, AlH₄, CN, SCN, or a combination thereof.

20. The electrochemical cell of claim 15, wherein the anode layer comprises silicon, lithium, carbon, magnesium, indium, gallium, aluminum, calcium, silver, or tin.
